(19) United States
(12) Patent Application Publication
(10) Pub. No.: US 2022/0117176 A1
(43) Pub. Date: Apr. 21, 2022

(54) DEVICE FOR ACCOMMODATING AND SUPPORTING A POT PLANT

(71) Applicant: Pes Lab S.r.l., Catania (CT) (IT)

(72) Inventor: Anna GENNARO, Catania (CT) (IT)

(21) Appl. No.: 17/209,792

(22) Filed: Mar. 23, 2021

(30) Foreign Application Priority Data
Oct. 19, 2020 (IT) 102020000024523

(51) Int. Cl. A01G 29/00; A01G 7/04; A01G 9/02; A01G 27/00

(52) U.S. Cl. CPC A01G 29/00; A01G 7/045; A01G 7/04; A01G 27/006; A01G 27/001; A01G 27/003; A01G 9/02

(57) ABSTRACT

The disclosed device accommodates and supports a pot plant, including a PLC communicating with an application on a mobile electronic apparatus. Sensors monitor the life cycle of the plant, and equipment provides the plant nourishment, hydration and light. Upon selecting the plant to be grown, the application creates an avatar of the plant. The application imports parameters of the selected plant from a database and communicates them to the PLC which, in turn, receives information from the sensors included in the device, operating the plant support apparatuses. Whenever the plant has a need, an “alert” appears in the application recreating an emotion of the plant as an emoticon and sends a push button. Pressing the button allows the PLC to issue commands for activating the apparatuses. The application further shows a dashboard providing updates regarding the current conditions of the plant and the residual availability of water and fertilizer.

### CROSS-REFERENCE TO RELATED APPLICATIONS

This application claims priority to IT application No. 102020000024523 filed Oct. 19, 2020, the entire contents of which is hereby incorporated by reference.

### BACKGROUND OF THE INVENTION

### Field of the Invention

The present invention finds application in the field of the cultivation of so-called “pot plants”, i.e., plants with a root system which may be cultivated outside of the natural environment thereof by placing the root system thereof in a suitable substrate accommodated in a container commonly called “pot”.

More precisely, the present invention relates to a device adapted to at least partially accommodate and support a plant of the aforesaid type.

### Description of the Related Art

As it is known, when a plant is cultivated in a pot, it needs more attention with respect to plants which grow outdoors in the natural environment thereof. When cultivating a pot plant, it is necessary, for example, to periodically administer water to the latter together with so-called “fertilizers”, i.e., substances capable of stimulating the development of the plant. Water and fertilizers are usually deposited at the substrate where the roots of the plant are at least partially immersed.

The periodic administration of water and fertilizers, as well as the control and adjustment of parameters, such as the temperature of the environment in which the plant grows and the light exposure of the latter, force a person assigned to the custody of a pot plant not to leave it for relatively long periods of time.

### SUMMARY OF THE INVENTION

It is the object of the present invention to overcome the aforesaid drawbacks by indicating a device for accommodating and supporting, at least partially, a pot plant, which may be remotely controlled by means of a mobile electronic apparatus, i.e., an electronic apparatus whose use does not place restrictions on the mobility of a user thereof. Among the mobile electronic apparatuses there are, by way of explanation, smartphones (i.e., mobile phones capable of performing some functions conventionally performed by a computer) and compact laptop computers (i.e., consisting of a parallelepiped body of a reduced size and weight).

The object of the present invention is a device adapted to accommodate and support, at least partially, a plant provided with a root system, said device comprising:
at least one container (corresponding, by way of explanation, to a pot) including one or more walls delimiting, at least partially:
   a seat where there may be accommodated:
      a substrate for a plant provided with a root system;
      said plant at least at said root system, with the latter at least partially immersed in said substrate;
   an opening to access said seat,
      said substrate and said root system being insertable in said seat and being extractable from the latter through said opening;
a first tank adapted to accommodate water therein;
a first sensor adapted to detect whether an amount of water which is lower than a first limit value is accommodated in said first tank.
Said first sensor is preferably adapted to measure the amount of water possibly present in said first tank;
a second tank adapted to accommodate therein a fertilizer solution for a plant which may be at least partially accommodated in said seat at an own root system;
a second sensor adapted to detect whether an amount of fertilizer solution which is lower than a second limit value is accommodated in said second tank.

Said second sensor, similarly to said first sensor, is preferably adapted to measure the amount of fertilizer solution possibly present in said second tank;
pumping means communicating with said seat and with said first and second tanks,
said pumping means being adapted to:
   withdraw an amount of water from said first tank when water is accommodated in said first tank;
   withdraw an amount of fertilizer solution from said second tank when a fertilizer solution is accommodated in said second tank;
   mix the amount of water withdrawn from said first tank with the amount of fertilizer solution withdrawn from said second tank so as to obtain a mixture;
   introduce said mixture into said seat, and especially into said substrate when accommodated in said seat.

Said pumping means preferably comprise an immersion pump accommodated in said first tank or in said second tank;
a third temperature sensor, at least partially accommodated in said seat and adapted to measure the temperature of at least a first portion of a substrate when the latter is accommodated in said seat;
a fourth humidity sensor, at least partially accommodated in said seat and adapted to measure the degree of humidity of at least a second portion of a substrate when the latter is accommodated in said seat.
Incidentally, the first and second portion of the substrate may coincide, even only partially;
an actuator adapted to rotate said container about an axis so as to adjust the light exposure of a plant whose root system is accommodated in said seat,
said container being capable of resting on a plane,
said actuator being such that, when said container rests on a plane, said axis is arranged orthogonally to said plane.

Said actuator preferably acts as a support which may rest on said plane, and on which said container may be rested at a portion thereof opposite to said opening. Said container is preferably capable of resting on a plane by means of said actuator so that, when said container rests on a plane, said actuator is interposed between said plane and said container.

Said actuator preferably comprises a motorized rotating platform on which the container rests;
a fifth brightness sensor, adapted to measure the intensity of the light in a portion of space outside said container and placed above said opening when said container rests on one plane;
artificial light emitter means,
said emitter means being adapted to emit artificial light in said portion of space outside said container and placed above said opening when said container rests on a plane;
means for transducing electric current into sound waves, said transducer means being adapted to emit sound waves in said portion of space outside said container and placed above said opening when said container rests on a plane.

Said transducer means preferably comprise at least one loudspeaker;
control means connected to said first, second, third, fourth and fifth sensors, to said pumping means, to said actuator, to said emitter means and to said transducer means,
said control means being adapted to:
   know, by means of said first sensor, whether an amount of water which is lower than said first limit value is accommodated in said first tank;
   know, by means of said second sensor, whether an amount of fertilizer solution which is lower than said second limit value is accommodated in said second tank;
   acquire, by means of said third sensor, the temperature of at least said first portion of substrate when the latter is accommodated in said seat;
   acquire, by means of said fourth sensor, the degree of humidity of at least said second portion of substrate when the latter is accommodated in said seat;
   acquire, by means of said fifth sensor, the intensity of the light in said portion of space outside said container and placed above said opening when said container rests on a plane;
   operate said pumping means so as to:
      withdraw a determined amount of water from said first tank when water is accommodated in said first tank;
      withdraw a determined amount of fertilizer solution from said second tank when said fertilizer solution is accommodated in said second tank;
      mix the determined amount of water withdrawn from said first tank with the determined amount of fertilizer solution withdrawn from said second tank so as to obtain a mixture;
      introduce said determined mixture into said seat and especially into said substrate when accommodated in said seat;
   operate said actuator so as to make said container rotate about said axis for a determined width and in a determined direction;
   operate said emitter means so as to emit artificial light in said portion of space outside said container and placed above said opening when said container rests on a plane;
   operate said transducer means so as to emit sound waves in said portion of space outside said container and placed above said opening when said container rests on a plane;
radio-frequency electromagnetic waves transceiver means,
said transceiver means being connected to said control means and being connectable, by means of electromagnetic waves transceived thereby, to a mobile electronic apparatus,
when said device, by means of said transceiver means, is connected to a mobile electronic apparatus, said control means being adapted to communicate to said mobile electronic apparatus, by transceiving radio-frequency electromagnetic waves:
   whether an amount of water which is lower than said first limit value is accommodated in said first tank;
   whether an amount of fertilizer solution which is lower than said second limit value is accommodated in said second tank;
   the temperature, acquired by means of said third sensor, of at least said first portion of substrate when the latter is accommodated in said seat;
   the degree of humidity, acquired by means of said fourth sensor, of at least said second portion of substrate when the latter is accommodated in said seat;
   the intensity of the light, acquired by means of said fifth sensor, in said portion of space outside said container and placed above said opening when said container rests on a plane,
when said device, by means of said transceiver means, is connected to a mobile electronic apparatus, said control means being further adapted to receive from said mobile electronic apparatus, by transceiving radio-frequency electromagnetic waves:
   a command for operating said pumping means so as to:
      withdraw a determined amount of water from said first tank when water is accommodated in said first tank;
      withdraw a determined amount of fertilizer solution from said second tank when said fertilizer solution is accommodated in said second tank;
      mix the determined amount of water withdrawn from said first tank with the determined amount of fertilizer solution withdrawn from said second tank so as to obtain a mixture;
      introduce said determined mixture into said seat and especially into said substrate when accommodated in said seat;
   a command for operating said actuator so as to make said container rotate about said axis for a determined width and in a determined direction;
   a command for operating said emitter means so as to emit artificial light in said portion of space outside said container and placed above said opening when said container rests on a plane;
   a command for operating said transducer means so as to emit sound waves in said portion of space outside said container and placed above said opening when said container rests on a plane,
said mobile electronic device to which said device is connectable by means of said transceiver means being adapted to:
   access a database containing information relating to a plurality of plants, each of which has a root system,
   for each plant of said plurality, said database containing at least the following information:
      a preferred temperature of the substrate in which the root system of said plant is at least partially immersible;
      a preferred degree of humidity of the substrate in which the root system of said plant is at least partially immersible;
      a maximum intensity of light to which said plant must be exposed;
   allow a user of said mobile electronic apparatus to select a plant from said database;
   when said device, by means of said transceiver means, is connected to said mobile electronic apparatus, communicate to a user of said mobile electronic device:
      whether an amount of water which is lower than said first limit value is accommodated in said first tank;
      whether an amount of fertilizer solution which is lower than said second limit value is accommodated in said second tank;
      the temperature of at least said first portion of substrate, when the latter is accommodated in said seat, communicated by said control means;
      the degree of humidity of at least said second portion of substrate, when the latter is accommodated in said seat, communicated by said control means;
      the intensity of the light in said portion of space outside said container and placed above said opening when said container rests on a plane, communicated by said control means;
   when said device, by means of said transceiver means, is connected to said mobile electronic apparatus and a user of said mobile electronic apparatus has selected a plant from said database, communicate to said user every time:
      the temperature of at least said first portion of substrate, when the latter is accommodated in said seat, communicated by said control means, is different from the preferred temperature of the plant selected from said database by said user;
      the degree of humidity of at least said second portion of substrate, when the latter is accommodated in said seat, communicated by said control means, is different from the preferred degree of humidity of the plant selected from said database by said user;
      the intensity of the light in said portion of space outside said container and placed above said opening when said container rests on a plane, communicated by said control means, exceeds the maximum intensity of light to which the plant selected from said database by said user must be exposed;
   when said device, by means of said transceiver means, is connected to said mobile electronic apparatus, allow a user of said mobile electronic apparatus to provide, by means of the latter, said control means with a command for operating said pumping means so as to:
      withdraw a determined amount of water from said first tank when water is accommodated in said first tank;
      withdraw a determined amount of fertilizer solution from said second tank when said fertilizer solution is accommodated in said second tank;
      mix the determined amount of water withdrawn from said first tank with the determined amount of fertilizer solution withdrawn from said second tank so as to obtain a mixture;
      introduce said determined mixture into said seat and especially into said substrate when accommodated in said seat;
   when said device, by means of said transceiver means, is connected to said mobile electronic apparatus, allow a user of said mobile electronic apparatus to provide, by means of the latter, said control means with:
      a command for operating said actuator so as to make said container rotate about said axis for a determined width and in a determined direction;
      a command for operating said emitter means so as to emit artificial light in said portion of space outside said container and placed above said opening when said container rests on a plane;
      a command for operating said transducer means so as to emit sound waves in said portion of space outside said container and placed above said opening when said container rests on a plane.

The device object of the invention is adapted to accommodate, at least partially, a pot plant and is advantageously remotely controllable by means of a mobile electronic apparatus.

The transducer means comprised in the device object of the invention are adapted to emit sound waves at least partially impacting against a pot plant when the root system of said plant is at least partially accommodated in the seat of the container of the device. Advantageously, the impact of the sound waves against the plant gives rise to vibrations which stimulate the growth of said plant.

### BRIEF DESCRIPTION OF THE DRAWINGS

Further objects and advantages of the present invention will become apparent from the following detailed description of embodiments thereof and from the accompanying sole drawing FIGURE, illustrating a schematic view of the invention.

As the sole drawing FIGURE is purely schematic, the scale and proportions of the various illustrated elements do not necessarily correspond to the real values.

### DESCRIPTION OF THE PREFERRED EMBODIMENTS

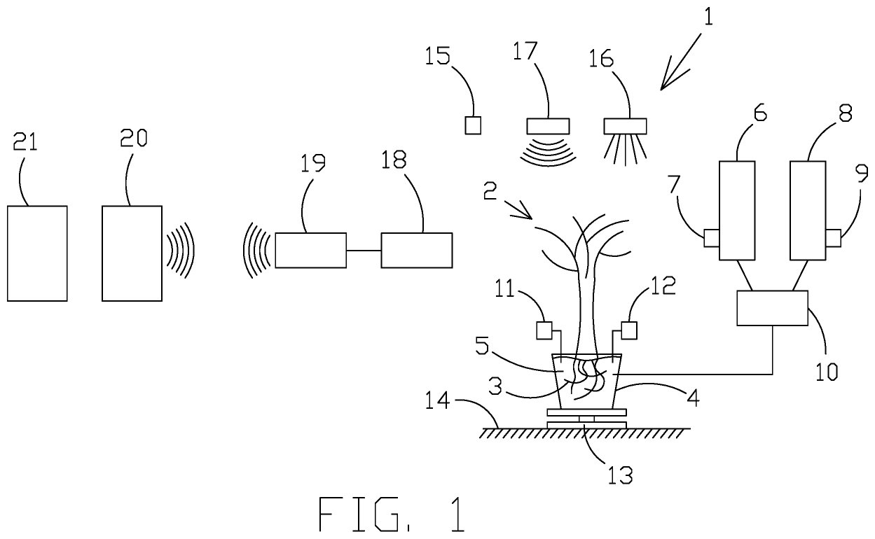

FIG. 1 shows a device 1, object of the invention, adapted to accommodate and support, at least partially, a plant 2 provided with a root system 3. The device 1 comprises at least one container 4 (corresponding, by way of explanation, to a pot) comprising one or more walls, at least partially delimiting a seat where a substrate 5, adapted to support the plant 2 and the root system 3, at least partially immersed in the substrate 5, may be accommodated. The walls of the container 4 further delimit an opening to access the aforesaid seat. The substrate 5 and the root system 3 are therefore insertable in the aforesaid seat and are extractable from the latter through said opening.

The device 1 comprises a first tank 6 adapted to accommodate water therein, and a first sensor 7 adapted to detect whether an amount of water which is lower than a limit value previously defined as “first limit value” is accommodated in the tank 6. The sensor 7 is preferably adapted to measure the amount of water present in the tank 6.

The device 1 further comprises a second tank 8 adapted to accommodate therein a fertilizer solution for the plant 2, and a second sensor 9 adapted to detect whether an amount of fertilizer solution which is lower than a previously limit value previously defined as “second limit value” is accommodated in the tank 8. The sensor 9, similarly to the sensor 7, is preferably adapted to measure the amount of fertilizer solution present in the tank 8.

A pump 10 communicates with the seat of the container 4 and with the tanks 6 and 8 so as to: take an amount of water from the tank 6 and an amount of fertilizer solution from the tank 8, mix the water taken from the tank 6 with the fertilizer solution taken from the tank 8 so as to obtain a mixture, and introduce said mixture into the seat of the container 4, especially in the substrate 5. Preferably, but not necessarily, the pump 10 is an immersion pump accommodated in the tank 6 or in the tank 8.

In addition to the sensors 7 and 9, the device 1 comprises a third temperature sensor 11, at least partially accommodated in the seat of the container 4 and adapted to measure the temperature of at least one portion of substrate 5 previously defined as “first portion of substrate”. A fourth humidity sensor 12 is also at least partially accommodated in the seat of the container 4 so as to measure the degree of humidity of at least one portion of substrate 5 previously defined as “second portion of substrate”. Incidentally and for the avoidance of doubt, the first and second portion of the substrate may coincide, even only partially.

The device 1 further comprises an actuator 13 adapted to rotate the container 4 about an axis. More precisely, the container 4 may be rested on a plane 14 and the actuator 13 is comprised in the device 1 so that, when the container 4 rests on the plane 14, the axis about which the container 4 is rotatable is arranged orthogonally with respect to the plane 14. The actuator 13 preferably, but not necessarily, acts as a support which may rest on the plane 14, and on which the container 4 may be rested at an own base opposite to the opening to access the seat of said container 4. In particular, the latter may be rested on the plane 14 by means of the actuator 13 so that, when the container 4 rests (indirectly) on the plane 14, the actuator 13 is interposed between the plane 14 and the container 4. The actuator 13 preferably corresponds to a motorized rotating platform on which the container 4 rests.

The device 1 comprises a fifth brightness sensor 15, adapted to measure the intensity of the light in a portion of space outside the container 4 and placed above the opening to access the seat of said container 4 when the latter rests on the plane 14.

The device 1 further comprises an apparatus 16 adapted to emit artificial light. The apparatus 16 corresponds, by way of explanation, to an LED lamp and is adapted to emit artificial light in the aforesaid portion of space outside the container 4 and placed above the opening to access the seat of said container 4 when the latter rests on the plane 14.

The device 1 further comprises an apparatus 17 adapted to emit sound waves. The apparatus 17 corresponds, by way of explanation, to a loudspeaker and is adapted to emit sound waves in the aforesaid portion of space outside the container 4 and placed above the opening to access the seat of said container 4 when the latter rests on the plane 14.

The sensors 7, 9, 11, 12 and 15, the pump 10, the platform 13, the lamp 16 and the loudspeaker 17 are connected to control means 18 preferably corresponding to a programmable logic controller (usually known by the acronym “PLC”). The latter, by means of the sensor 7, knows if in the tank 6 there is an amount of water which is lower than the aforesaid first limit value and, by means of the sensor 9, it knows if an amount of fertilizer solution which is lower than the aforesaid second limit value is accommodated in the tank 8. The PLC 18 further acquires, by means of the sensor 11, the temperature of the aforesaid first portion of substrate 5, by means of the sensor 12, the degree of humidity of the aforesaid second portion of substrate 5 and, by means of the sensor 15, the intensity of the light in the aforesaid portion of space outside the container 4 and placed above the opening to access the seat of said container 4 when the latter rests on the plane 14. The PLC 18 is capable of operating the pump 10 so as to: take a determined amount of water from the tank 6 and a determined amount of fertilizer solution from the tank 8, mix the water taken from the tank 6 with the fertilizer solution taken from the tank 8 so as to obtain a determined mixture, and introduce said determined mixture into the seat of the container 4, especially in the substrate 5. The PLC 18 is further capable of operating the platform 13 so as to rotate the container 4 about the aforesaid axis for a determined width and in a determined direction, to operate the lamp 16 so as to emit artificial light in the aforesaid portion of space outside the container 4 and placed above the opening to access the seat of said container 4 when the latter rests on the plane 14, and to operate the loudspeaker 17 so as to emit sound waves in the aforesaid portion of space outside the container 4 and placed above the opening to access the seat of said container 4 when the latter rests on the plane 14.

The PLC 18 is connected to an antenna 19 to transceive radio-frequency electromagnetic waves. By means of the latter and by means of the antenna 19, the PLC 18, and more generally the device 1, may be connected to a mobile electronic apparatus 20, such as, for example, a smartphone. The connection between the device 1 and the smartphone 20 may occur, by way of explanation, by means of the known Bluetooth™ technology and/or by means of a cellular mobile radio network to which both the device 1 and the smartphone 20 are connected.

Incidentally, in order for the device 1 to be connectable to a cellular mobile radio network, the latter is preferably provided with a SIM card by means of which the device 1 may be connected to the Internet. Alternatively, in the case where the device 1 is located in a geographical area with Wi-Fi™ coverage, the connection of the device 1 to the cellular mobile radio network may occur wirelessly by means of a connection to a local network in turn connected to the cellular mobile radio network.

When the device 1, by means of the antenna 19, is connected to the smartphone 20, the PLC 18 is capable of communicating to the smartphone 20, by transceiving radio-frequency electromagnetic waves, whether an amount of water which is lower than the aforesaid first limit value is accommodated in the tank 6 and whether an amount of fertilizer solution which is lower than the aforesaid second limit value is accommodated in the tank 8. The PLC 18 is further capable of communicating to the smartphone 20 the temperature, acquired by means of the sensor 11, of the aforesaid first portion of substrate 5, the degree of humidity, acquired by means of the sensor 12, of the aforesaid second portion of substrate 5 and the intensity of the light, acquired by means of the sensor 15, in the aforesaid portion of space outside the container 4 and placed above the opening to access the seat of said container 4 when the latter rests on the surface 14.

When the device 1, by means of the antenna 19, is connected to the smartphone 20, the PLC 18 is capable of receiving from the smartphone 20, by transceiving radio-frequency electromagnetic waves, a command to operate the pump 10 so as to: take a determined amount of water from the tank 6 and a determined amount of fertilizer solution from the tank 8, mix the water taken from the tank 6 with the fertilizer solution taken from the tank 8 so as to obtain a determined mixture, and introduce said determined mixture in the seat of the container 4, especially in the substrate 5. The PLC 18 is further capable of receiving from the smartphone 20 a command for operating the platform 13 so as to rotate the container 4 about the aforesaid axis for a determined width and in a determined direction, a command for operating the lamp 16 so as to emit artificial light in the aforesaid portion of space outside the container 4 and placed above the opening to access the seat of said container 4 when the latter rests on the plane 14, and a command for operating the loudspeaker 17 so as to emit sound waves in the aforesaid portion of space outside the container 4 and placed above the opening to access the seat of said container 4 when the latter rests on the plane 14.

The smartphone 20 may access a database 21 containing information relating to a plurality of plants, each of which has a root system. For each plant of said plurality, the database 21 contains the physiological parameters of the life cycle of the plant, and in particular at least the following information: a preferred temperature and a preferred degree of humidity of the substrate 5 and a maximum intensity of the light to which said plant is to be exposed. The smartphone 20, preferably by means of an application, allows a user to select a plant from the database 21.

When the device 1, by means of the antenna 19, is connected to the smartphone 20, the latter, by means of the aforesaid application, is capable of communicating to the aforesaid user: whether an amount of water which is lower than the aforesaid first limit value is accommodated in the tank 6, whether an amount of fertilizer solution which is lower than the aforesaid second limit value is accommodated in the tank 8, the temperature of the aforesaid first portion of substrate 5, the degree of humidity of the aforesaid second portion of substrate 5 and the intensity of the light in the aforesaid portion of space outside the container 4 and placed above the opening to access the seat of said container 4 when the latter rests on the surface 14.

When the device 1, by means of the antenna 19, is connected to the smartphone 20 and a user has selected a plant from the database 21, the smartphone 20, by means of the aforesaid application, is capable of communicating to the aforesaid user: every time the temperature of the aforesaid first portion of substrate 5 (communicated by the PLC 18) is different from the preferred temperature of the plant selected from the database 21, every time the degree of humidity of the aforesaid second portion of substrate 5 (communicated by the PLC 18) is different from the preferred degree of humidity of the plant selected from the database 21, and every time the intensity of the light in the aforesaid portion of space outside the container 4 and placed above the opening to access the seat of said container 4 when the latter rests on the plane 14 is greater than the maximum intensity of the light to which the plant selected from the database 21 is to be exposed.

When the device 1, by means of the antenna 19, is connected to the smartphone 20, the latter, by means of the aforesaid application, allows a user to provide the PLC 18 with a command to operate the pump 20 so as to: take a determined amount of water from the tank 6 and a determined amount of fertilizer solution from the tank 8, mix the water taken from the tank 6 with the fertilizer solution taken from the tank 8 so as to obtain a determined mixture, and introduce said determined mixture into the seat of the container 4, especially in the substrate 5.

When the device 1, by means of the antenna 19, is connected to the smartphone 20, the latter, by means of the aforesaid application, allows a user to provide the PLC 18 with a command for operating the platform 13 so as to rotate the container 4 about the aforesaid axis for a determined width and in a determined direction, a command for operating the lamp 16 so as to emit artificial light in the aforesaid portion of space outside the container 4 and placed above the opening to access the seat of said container 4 when the latter rests on the plane 14, and a command for operating the loudspeaker 17 so as to emit sound waves in the aforesaid portion of space outside the container 4 and placed above the opening to access the seat of said container 4 when the latter rests on the plane 14.

According to a variant of the device 1, the latter further comprises a heater capable of transferring heat to the air present in the aforesaid portion of space outside the container 4 and placed above the opening to access the seat of said container 4 when the latter rests on the surface 14. In such a case, also the heater is connected to the PLC 18 and the latter is capable of operating the heater so as to transfer heat to the air present in the aforesaid portion of space outside the container 4 and placed above the opening to access the seat of said container 4 when the latter rests on the plane 14. When the device 1 is connected to the smartphone 20, the PLC 18 is capable of receiving from the smartphone 20 a command for operating the heater, and a user of the smartphone 20, by means of the aforesaid application, is capable of providing the PLC 18 with a command for operating the heater.

With regard to the use of the device 1, a person, after having accommodated the plant 2 in the container 4 (i.e., the root system 3 in the substrate 5 in turn accommodated in the container 4), installs the above-mentioned application on the smartphone 20 thereof, selects the plant corresponding to the plant 2 from the database 21 and connects the smartphone 20 to the device 1. The PLC 18 communicates the information acquired by means of the sensors 7, 9, 11, 12 and 15 to the smartphone 20 which shows them to the user, by means of a “directional dashboard” comprised in the aforesaid application. When the ideal environmental parameters for the plant 2 (according to what is contained in the database 21) deviate from the values transmitted to the smartphone 20 by the PLC 18, the smartphone 20, by means of the aforesaid application, warns the user about the deviation and invites them to send a command to the PLC 18 so as to correct the deviation.

Based on the provided description of a preferred embodiment, it is apparent that changes may be introduced by a person skilled in the art without because of this departing from the scope of protection of the invention as defined by the following claims.

1. A device (1) adapted to accommodate and support, at least partially, a plant (2) provided with a root system (3),
said device (1) comprising:
at least one container (4) including one or more delimiting walls, at least partially:
a seat where it may be accommodated:
a substrate (5) for said plant (2);
said plant (2) at least at said root system (3), with the root system at least partially immersed in said substrate (5);
an opening to access said seat,
said substrate (5) and said root system (3) being insertable in said seat and being extractable from the seat through said opening;
a first tank (6) adapted to accommodate water therein;
a first sensor (7) adapted to detect whether an amount of water which is lower than a first limit value is accommodated in said first tank (6);
a second tank (8) adapted to house a fertilizer solution for said plant (2) therein;
a second sensor (9) adapted to detect whether an amount of fertilizer solution which is lower than a second limit value is accommodated in said second tank (8);
pumping means (10) communicating with said seat and with said first and second tanks (6, 8), said pumping means (10) being adapted to:
withdraw an amount of water from said first tank (6) when water is accommodated in said first tank (6);
withdraw an amount of fertilizer solution from said second tank (8) when a fertilizer solution is accommodated in said second tank (8);
mix the amount of water withdrawn from said first tank (6) with the amount of fertilizer solution withdrawn from said second tank (8) so as to obtain a mixture;
introduce said mixture into said seat or into said substrate (5) when accommodated in said seat,
said device (1) further comprising:
a third temperature sensor (11), at least partially accommodated in said seat and adapted to measure the temperature of at least a first portion of said substrate (5) when the substrate is accommodated in said seat;
a fourth humidity sensor (12), at least partially accommodated in said seat and adapted to measure the degree of humidity of at least a second portion of said substrate (5) when the substrate is accommodated in said seat;
an actuator (13) adapted to rotate said container (4) about an axis,
said container (4) capable of resting on a plane (14),
said actuator (13) being such that, when said container (4) rests on a plane (14), said axis is arranged orthogonally to said plane (14);
a fifth brightness sensor (15), adapted to measure the intensity of the light in a portion of space outside said container (4) and placed above said opening when said container (4) rests on one plane (14);
artificial light emitter means (16),
said emitter means (16) being adapted to emit artificial light in said portion of space outside said container (4) and placed above said opening when said container (4) rests on a plane (14);
means (17) for transducing electric current into sound waves,
said transducer means (17) being adapted to emit sound waves in said portion of space outside said container (4) and placed above said opening when said container (4) rests on a plane (14);
control means (18) connected to said first, second, third, fourth and fifth sensors (7, 9, 11, 12, 15), to said pumping means (10), to said actuator (13), to said emitter means (16) and to said transducer means (17),
said control means (18) being adapted to:
know, by means of said first sensor (7), whether an amount of water which is lower than said first limit value is accommodated in said first tank (6);
know, by means of said second sensor (9), whether an amount of fertilizer solution which is lower than said second limit value is accommodated in said second tank (8);
acquire, by means of said third sensor (11), the temperature of at least said first portion of said substrate (5) when the substrate is accommodated in said seat;
acquire, by means of said fourth sensor (12), the degree of humidity of at least said second portion of said substrate (5) when the substrate is accommodated in said seat;
acquire, by means of said fifth sensor (15), the intensity of the light in said portion of space outside said container (4) and placed above said opening when said container (4) rests on a plane (14);
operate said pumping means (10) so as to:
withdraw a determined amount of water from said first tank (6) when water is accommodated in said first tank (6);
withdraw a determined amount of said fertilizer solution from said second tank (8) when said fertilizer solution is accommodated in said second tank (8);
mix the determined amount of water withdrawn from said first tank (6) with the determined amount of fertilizer solution withdrawn from said second tank (8) so as to obtain a mixture;
introduce said determined mixture into said seat or into said substrate (5) when accommodated in said seat;
operate said actuator (13) so as to make said container (4) rotate about said axis for a determined width and in a determined direction;
operate said emitter means (16) so as to emit artificial light in said portion of space outside said container (4) and placed above said opening when said container (4) rests on a plane (14);
operate said transducer means (17) so as to emit sound waves in said portion of space outside said container (4) and placed above said opening when said container (4) rests on a plane (14);
radio-frequency electromagnetic waves transceiver means (19),
said transceiver means (19) being connected to said control means (18) and being connectable, by means of electromagnetic waves transceived thereby, to a mobile electronic apparatus (20), when said device (1), by means of said transceiver means (19), is connected to a mobile electronic apparatus (20), said control means (18) being adapted to communicate to said mobile electronic apparatus (20), by transceiving radio-frequency electromagnetic waves:
whether an amount of water which is lower than said first limit value is accommodated in said first tank (6);
whether an amount of fertilizer solution which is lower than said second limit value is accommodated in said second tank (8);
the temperature, acquired by means of said third sensor (11), of at least said first portion of said substrate (5) when the substrate is accommodated in said seat;
the degree of humidity, acquired by means of said fourth sensor (12), of at least said second portion of said substrate (5) when the substrate is accommodated in said seat;
the intensity of the light, acquired by means of said fifth sensor (15), in said portion of space outside said container (4) and placed above said opening when said container (4) rests on a plane (14);
when said device (1), by means of said transceiver means (19), is connected to a mobile electronic apparatus (20), said control means (18) being further adapted to receive from said mobile electronic apparatus (20), by transceiving radio-frequency electromagnetic waves:
a command for operating said pumping means (10) so as to:
withdraw a determined amount of water from said first tank (6) when water is accommodated in said first tank (6);
withdraw a determined amount of said fertilizer solution from said second tank (8) when said fertilizer solution is accommodated in said second tank (8);
mix the determined amount of water withdrawn from said first tank (6) with the determined amount of fertilizer solution withdrawn from said second tank (8) so as to obtain a mixture;
introduce said determined mixture into said seat or into said substrate (5) when accommodated in said seat;
a command for operating said actuator (13) so as to make said container (4) rotate about said axis for a determined width and in a determined direction;
a command for operating said emitter means (16) so as to emit artificial light in said portion of space outside said container (4) and placed above said opening when said container (4) rests on a plane (14);
a command for operating said transducer means (17) so as to emit sound waves in said portion of space outside said container (4) and placed above said opening when said container (4) rests on a plane (14),
said mobile electronic device (20) to which said device (1) is connectable by means of said transceiver means (19) being adapted to:
access a database (21) containing information relating to a plurality of plants, each of which has a root system,
for each plant of said plurality, said database containing at least the following information:
a preferred temperature of a substrate wherein the root system of said plant is at least partially immersible;
a preferred degree of humidity of a substrate wherein the root system of said plant is at least partially immersible;
a maximum intensity of light to which said plant must be exposed;
allow a user of said mobile electronic apparatus (20) to select a plant from said database;
when said device (1), by means of said transceiver means (19), is connected to said mobile electronic apparatus (20), communicate to a user of said mobile electronic device (20):
whether an amount of water which is lower than said first limit value is accommodated in said first tank (6);
whether an amount of said fertilizer solution which is lower than said second limit value is accommodated in said second tank (8);
the temperature of at least said first portion of said substrate (5), when the substrate is accommodated in said seat, communicated by said control means (18);
the degree of humidity of at least said second portion of said substrate (5), when the substrate is accommodated in said seat, communicated by said control means (18);
the intensity of the light in said portion of space outside said container (4) and placed above said opening when said container (4) rests on a plane (14), communicated by said control means (18);
when said device (1), by means of said transceiver means (19), is connected to said mobile electronic apparatus (20) and a user of said mobile electronic apparatus (20) has selected a plant from said database (21), communicate to said user every time:
the temperature of at least said first portion of said substrate (5), when the substrate is accommodated in said seat, communicated by said control means (18), is different from the preferred temperature of the plant selected from said database (21) by said user;
the degree of humidity of at least said second portion of said substrate (5), when the substrate is accommodated in said seat, communicated by said control means (18), is different from the preferred degree of humidity of the plant selected from said database (21) by said user;
the intensity of the light in said portion of space outside said container (4) and placed above said opening when said container (4) rests on a plane (14), communicated by said control means (18), exceeds the maximum intensity of light to which the plant selected from said database (21) by said user must be exposed;
when said device (1), by means of said transceiver means (19), is connected to said mobile electronic apparatus (20), allow a user of said mobile electronic apparatus (20) to provide, by means of the mobile electronic apparatus, said control means (18) with a command for operating said pumping means (10) so as to:
withdraw a determined amount of water from said first tank (6) when water is accommodated in said first tank (6);
withdraw a determined amount of said fertilizer solution from said second tank (8) when said fertilizer solution is accommodated in said second tank (8);
mix the determined amount of water withdrawn from said first tank (6) with the determined amount of fertilizer solution withdrawn from said second tank (8) so as to obtain a mixture;
introduce said determined mixture into said seat or into said substrate (5) when accommodated in said seat;
when said device (1), by means of said transceiver means (19), is connected to said mobile electronic apparatus (20), allow a user of said mobile electronic apparatus (20) to provide, by means of the mobile electronic apparatus, said control means (18) with:
a command for operating said actuator (13) so as to make said container (4) rotate about said axis for a determined width and in a determined direction;
a command for operating said emitter means (16) so as to emit artificial light in said portion of space outside said container (4) and placed above said opening when said container (4) rests on a plane (14);
a command for operating said transducer means (17) so as to emit sound waves in said portion of space outside said container (4) and placed above said opening when said container (4) rests on a plane (14).

2. The device (1) according to claim 1, wherein said first sensor (7) is adapted to measure the amount of water present in said first tank (6).

3. The device (1) according to claim 1, wherein claim 1 or 2, said second sensor (9) is adapted to measure the amount of said fertilizer solution present in said second tank (8).

4. The device (1) according to claim 1, wherein said pumping means (10) comprise an immersion pump accommodated in said first tank (6) or in said second tank (8).

5. The device (1) according to claim 1, wherein said actuator (13) acts as a support which may rest on a plane (14), and on which said container (4) may be rested at an own portion opposite to said opening,
said container (4) being capable of resting on a plane (14) by means of said actuator (13) so that, when said container (4) rests on a plane (14), said actuator (13) is interposed between said plane (14) and said container (4).

6. The device (1) according to claim 2, wherein said second sensor (9) is adapted to measure the amount of said fertilizer solution present in said second tank (8).

7. The device (1) according to claim 2, wherein said pumping means (10) comprise an immersion pump accommodated in said first tank (6) or in said second tank (8).

8. The device (1) according to claim 3, wherein said pumping means (10) comprise an immersion pump accommodated in said first tank (6) or in said second tank (8).

9. The device (1) according to claim 4, wherein said pumping means (10) comprise an immersion pump accommodated in said first tank (6) or in said second tank (8).

10. The device (1) according to claim 2, wherein said actuator (13) acts as a support which may rest on a plane (14), and on which said container (4) may be rested at an own portion opposite to said opening,
said container (4) being capable of resting on a plane (14) by means of said actuator (13) so that, when said container (4) rests on a plane (14), said actuator (13) is interposed between said plane (14) and said container (4).

11. The device (1) according to claim 3, wherein said actuator (13) acts as a support which may rest on a plane (14), and on which said container (4) may be rested at an own portion opposite to said opening,
said container (4) being capable of resting on a plane (14) by means of said actuator (13) so that, when said container (4) rests on a plane (14), said actuator (13) is interposed between said plane (14) and said container (4).

12. The device (1) according to claim 4, wherein said actuator (13) acts as a support which may rest on a plane (14), and on which said container (4) may be rested at an own portion opposite to said opening,
said container (4) being capable of resting on a plane (14) by means of said actuator (13) so that, when said container (4) rests on a plane (14), said actuator (13) is interposed between said plane (14) and said container (4).

13. The device (1) according to claim 6, wherein said actuator (13) acts as a support which may rest on a plane (14), and on which said container (4) may be rested at an own portion opposite to said opening,
said container (4) being capable of resting on a plane (14) by means of said actuator (13) so that, when said container (4) rests on a plane (14), said actuator (13) is interposed between said plane (14) and said container (4).

14. The device (1) according to claim 7, wherein said actuator (13) acts as a support which may rest on a plane (14), and on which said container (4) may be rested at an own portion opposite to said opening,
said container (4) being capable of resting on a plane (14) by means of said actuator (13) so that, when said container (4) rests on a plane (14), said actuator (13) is interposed between said plane (14) and said container (4).

15. The device (1) according to claim 8, wherein said actuator (13) acts as a support which may rest on a plane (14), and on which said container (4) may be rested at an own portion opposite to said opening,
said container (4) being capable of resting on a plane (14) by means of said actuator (13) so that, when said container (4) rests on a plane (14), said actuator (13) is interposed between said plane (14) and said container (4).

16. The device (1) according to claim 9, wherein said actuator (13) acts as a support which may rest on a plane (14), and on which said container (4) may be rested at an own portion opposite to said opening,
said container (4) being capable of resting on a plane (14) by means of said actuator (13) so that, when said container (4) rests on a plane (14), said actuator (13) is interposed between said plane (14) and said container (4).
